(19) United States
(12) Patent Application Publication
(10) Pub. No.: US 2010/0079592 A1
(43) Pub. Date: Apr. 1, 2010

(54) Method for Monitoring a Predetermined Photographed Area Via A Website

(76) Inventors: John Traywick, Hoover, AL (US); Daniel Ulrich, Hamilton, OH (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/560,779

(22) Filed: Sep. 16, 2009

Related U.S. Application Data
(60) Provisional application No. 61/100,495, filed on Sep. 26, 2008.

(51) Int. Cl. H04N 7/18

(52) U.S. Cl. 348/143; 348/E07.085

(57) ABSTRACT

A method for monitoring an area with digital cameras via the Internet is disclosed which uses a database and server to provide user interface to the camera and storage capabilities.

### RELATED APPLICATION

This application claims priority to U.S. provisional patent application No. 61/100,495, filed Sep. 26, 2008, which is incorporated herewith by reference.

### FIELD OF THE INVENTION

The present invention relates to remote cameras used to monitor activity in a distributed area such as a hunting preserve or a portion of the preserve. In greater particularity the present invention relates to a system and method for monitoring a predetermined area to help hunters and game managers in managing the various photographs that are taken on their property with game cameras.

### BACKGROUND

Modern hunting has developed a number of tools to assist in both the management of the wildlife area and the location of the game within a managed area. Specifically, within the arsenal of tools, advances have been made in the use of surveillance cameras. Early “game” cameras utilized cumbersome triggering devices and film cameras. Current “game” cameras are often digital cameras actuated by passive infrared sensors to capture and store images of activity near the camera. However, because the cameras and motion detectors have limited range within which they can obtain usable images, a single camera provides limited information and cannot statistically be considered as representative of the activity over an entire management area. Consequently, multiple cameras at distinct locations spread over the management area are needed to adequately monitor the activity in a management area. Even with the high storage memory capabilities of most game cameras, it is necessary to retrieve the images by manually going to the cameras and downloading the images from memory to a PDA, or similar device, or retrieving the memory card and replacing it with another memory card. Either circumstance is somewhat disruptive to the management area because of the obvious human intrusion.

The present invention advances the art by providing a plurality of cameras for selective location within the target area, with each camera of said plurality of cameras having an associated communications device that allows data, including digital images, to be transmitted wirelessly to a server on a distributed computer network such as the internet for review, recordation and registration of the data by selected categories.

### BRIEF DESCRIPTION OF THE DRAWINGS

FIG. 1 is a block diagram of the components of the system for monitoring a predetermined area;

FIG. 2 is a map of the game management website used to monitor the predetermined area; and

FIGS. 3-12 are examples of web pages implemented to provide monitoring of a predetermined area.

FIG. 13 is a diagram illustrating data communications between a game management server and camera, via a cellular modem.

### DETAILED DESCRIPTION OF THE PREFERRED EMBODIMENTS

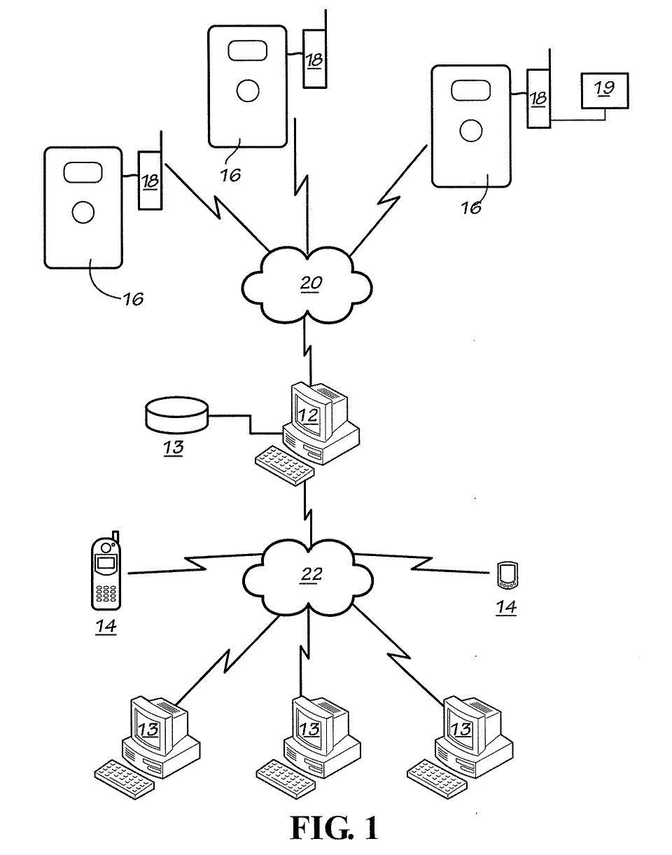

A system for monitoring a predetermined area via a website is illustrated in the attached drawings. Referring to FIG. 1 a system 10 is implemented utilizing at least one digital camera 16, a wireless communication device 18, such as cell phone modem, satellite phone modem, or wife device, in electronic communication with the camera 16 for picture and data transfer, a central administrative server 12 for receiving picture and data from the wireless communication device 18, and a third party machine to machine (M2M) network 20, such as a cellular telecommunications network or distributed computer network, connecting the wireless communication device 18 with the server 12. The system 10 may additionally include one or more sensors or data collection devices which may be integrated into the game camera, connected to the wireless communication device 18, including a GPS device that provides the precise location of the associated camera 16 in the field. Camera 16 includes a triggering mechanism such as a passive infrared sensor as is well known in the art and may be referred to as a “game camera.” The server 12 has access to and will maintain an associated electronic database 13 for storage of the pictures and data transferred from the cameras 16 and sensors. The server 12 also supports a functional website to view, organize and store the images and associated data. Finally, the system 10 includes any number of client central processing units 14 or related electronic devices (such as a cell phones, PDA's, or similar device known in the art) that may access the website supported by the server 12 via a global computer network (internet) 22 or a similar network. It should be noted that in some installations the global computer network 22 can also serve as the M2M network 20.

In operation, the cameras 16 will be placed in one or more desired locations. Each camera 16 will capture images according to a desired method of control that is implemented with conventional cameras, such as according to detection of a motion sensor or via a timer connected to, or incorporated within, the camera 16. Preferably, the captured image, which may be a digital still picture or video clip, is stored as an image file in the memory of the camera 16, which can be any type of memory known in the art. The server 12, at a predetermined interval, may then contact the wireless communication device 18 via the machine to machine network 20 to retrieve all image files and data acquired since the time that the server 12 last made contact with the camera 16. The interval between contact may be a predetermined interval of time or responsive to message data sent from the server 12 to the camera 16. In addition to the image file, the camera 16 will provide information concerning the picture, such as the time that the picture was taken (preferably as determined by a clock connected to or incorporated within electronic circuitry of the digital camera 16).

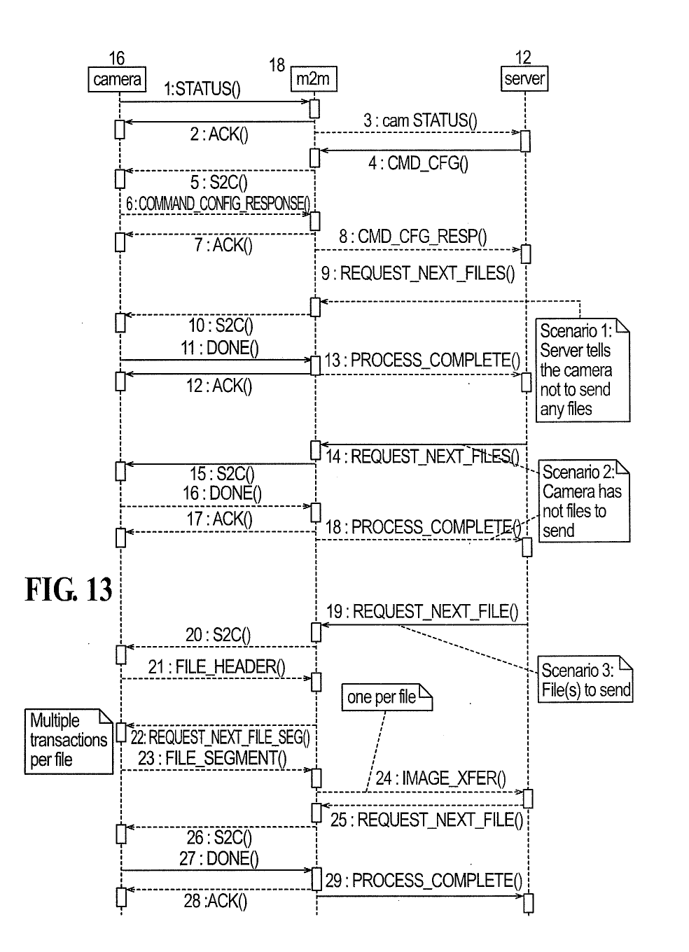

Exemplars of data communications between the server 12 and the wireless communication device 18 and the camera 16 are illustrated in FIG. 13. Communications between the camera 16 and the server 12 may be initiated on conditions such as: during the camera's power on sequence, at a specified date-time group based on server settings received by the camera, on the occurrence of a new image being taken by the camera when enabled by the user, or upon receipt of a wake-up signal received by the wireless communication device 18. A camera initiated communication of camera 16 status information to the server 12 is illustrated in lines 1-8. An example of a server initiated request to change camera settings is illustrated in lines 9-13, as indicated in Scenario 1. In this instance the server 12 instructs the camera 16 not to send any files. In Scenario 2, shown in lines 14-18, the server 12 requests that the camera 16 send image files to the server 12, but the camera 16 communicates data indicating it has no files to send. Finally, in Scenario 3, a server 12 request to the camera 16 to transmit files is illustrated at lines 19-29, in which multiple files are transmitted to the server 12.

If the server is connected to the camera system 18 via a wireless device which is not internet compatible and therefore relies on a machine to machine wireless interface, the image files may be sent to the server in segments, whereupon the server will reconstruct the file for storage and display. The camera status information available through the server 12 would include memory status where the memory is not cleared after each download, battery life for the camera, battery life for the wireless communication device, an error log, and event log which may log images captured or motion actuated triggers or both.

Associated data may also be transmitted from other sensors connected to the wireless communication device 18. One such sensor connected to the wireless communication device 18 is a GPS sensor 19, which may be a plug-in unit known in the art that may be connected to or embedded with the wireless communication device 18. The GPS sensor 19 functions to locate a set of GPS coordinates for the camera location, and it will provide the GPS coordinate data to the wireless communication device 18 just before the wireless communication device 18 transmits a batch of pictures to the server 12. The server 12 will receive the batch of picture files and related information (e.g., coordinate data from the GPS sensor), and will associate or tag each of the picture files with the associated GPS data as they are received by the server 12. The GPS information associated with the image file can be used on the game management website to create a database 13 of points by which a user can sort images. Further, using the stored GPS coordinates for a particular image file, the user may also automatically plot the location of the digital picture on an aerial map of a hunter's property using one of a plurality of aerial, topographic, or other mapping software programs known in the art.

Other sensors 19, such as one or more thermometers, clocks, wind sensors or barometers, may also be connected to the camera 16 or the wireless communication device 18, so that each digital picture may also be selectively associated with data provided by the other sensors 19, i.e, time, date, temperature, and barometric pressure, as well as other factors that the user may desire to be associated with the time and location of the photograph. Moon phase for the date, time and location can be calculated and associated with each image file. Associating such information with the image by the server 12 provides user selectable fields, such as a location name (e.g., “Greenfield1”) which can be used by server 12 to store and build a database of pictures having these data fields that can later be queried by the user.

As an example, a customer could access the website from a personal computer, internet capable phone or PDA 14, and enter a query to the server 12 to provide pictures from a camera 16 according to certain conditions or factors. For example, a hunter could enter a search to view all of the images for a group of cameras 16 that were taken when the temperature was below 32 degrees. Other reports could be run based on moon phase, date, barometric pressure and location names to give a hunter a broader picture of the wildlife movement patterns on a given property.

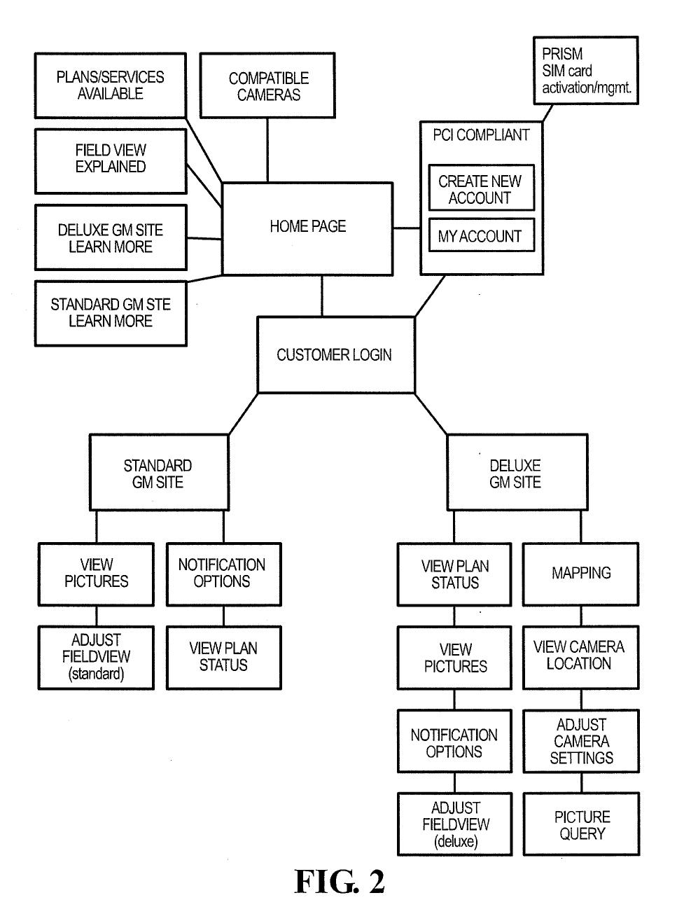

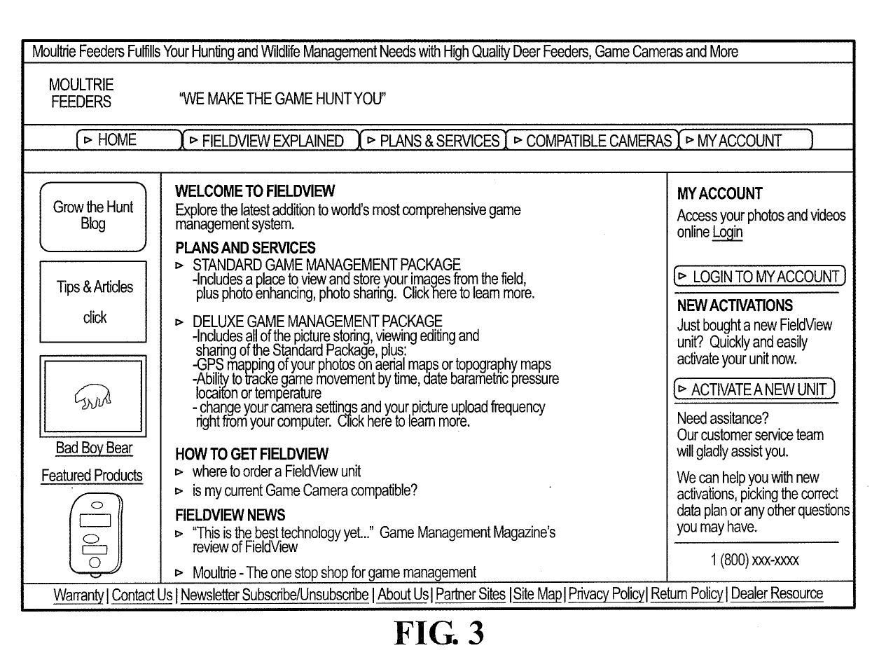

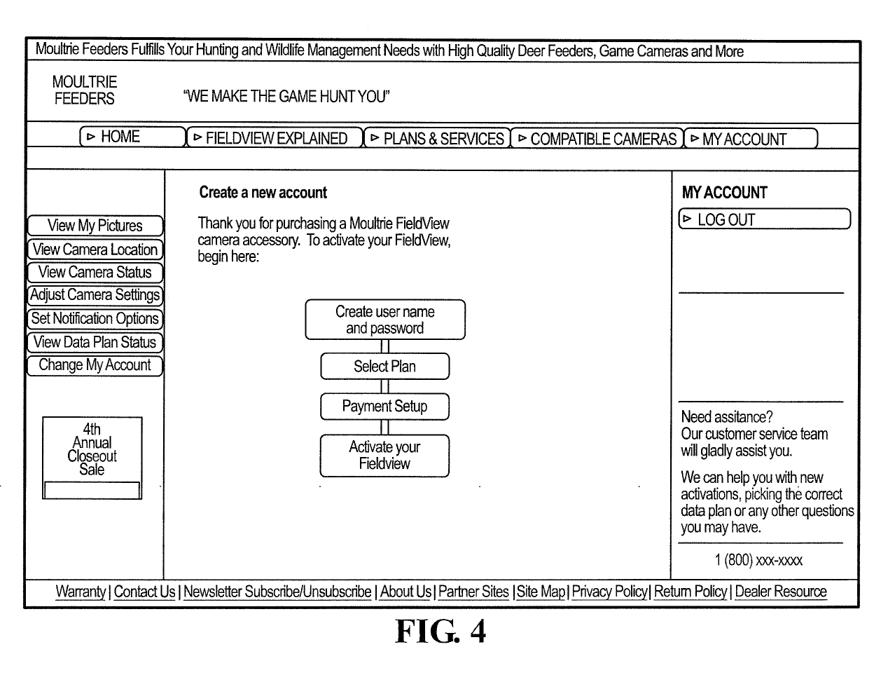

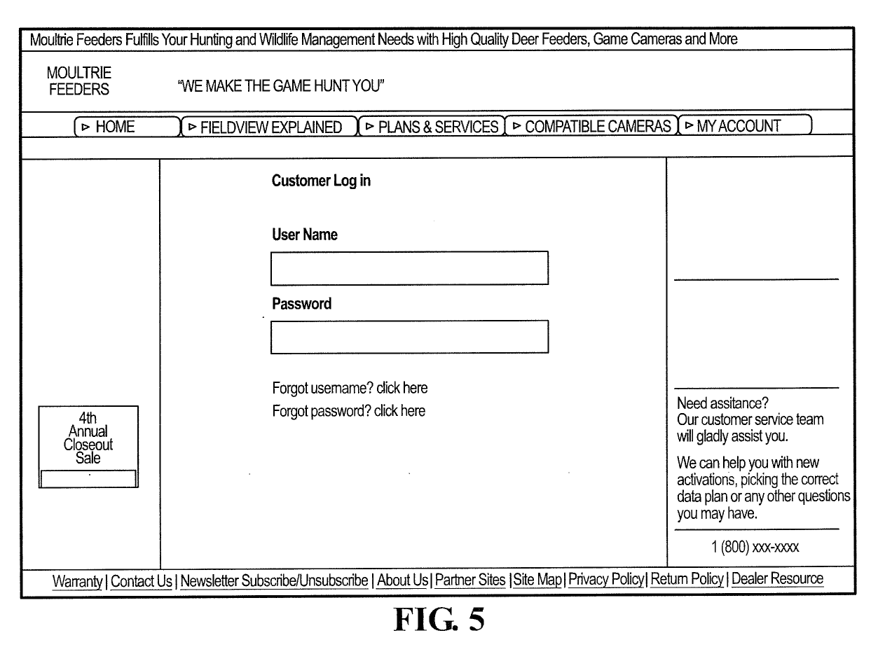

Looking further to FIG. 2, a map of the game management website maintained by the server 12 is illustrated. The game management website will have a page (see FIG. 3) serving as an interface for the general public to access and allow customers to set up accounts associated with one or more cameras 16 in the field. The home page of the website will provide relevant information for operation, including a list of cameras 16 available for purchase that are compatible with the system 10, a list of plans and services available (see FIG. 4), an explanation of the various views provided, and information about the packages available. The home page will also allow the user to create a new account with a payment system that is Payment Card Industry (PCI) compliant.

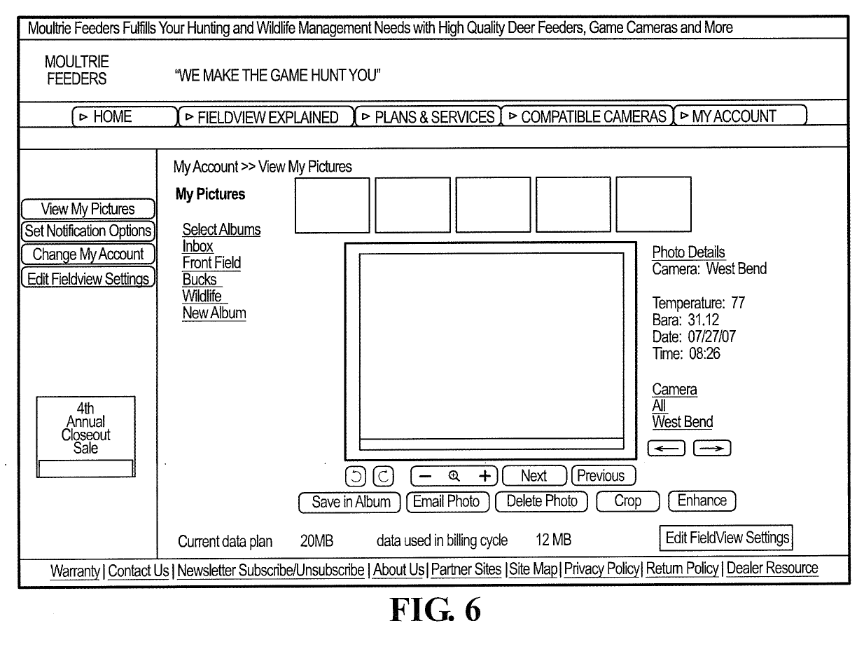

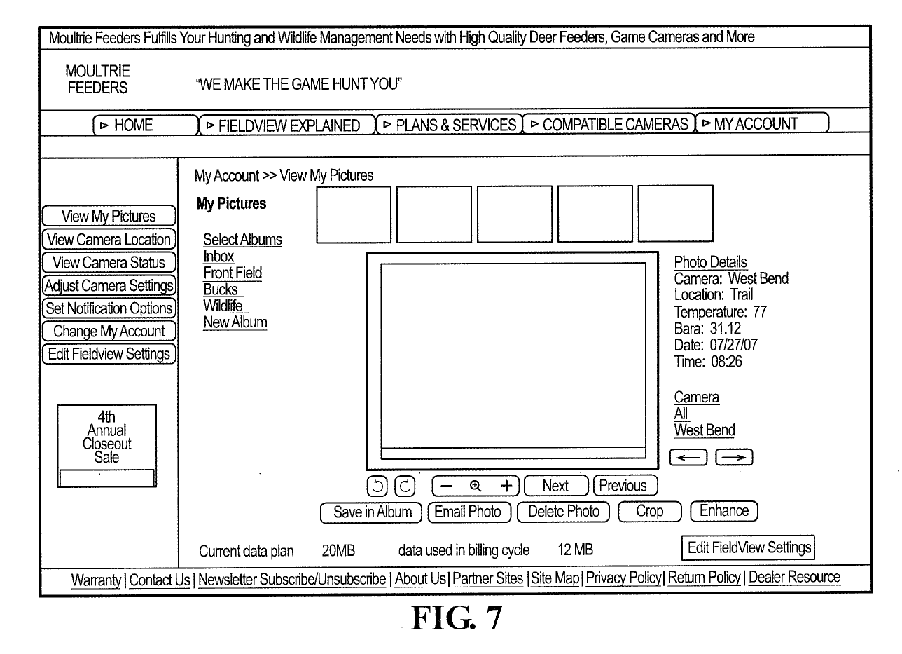

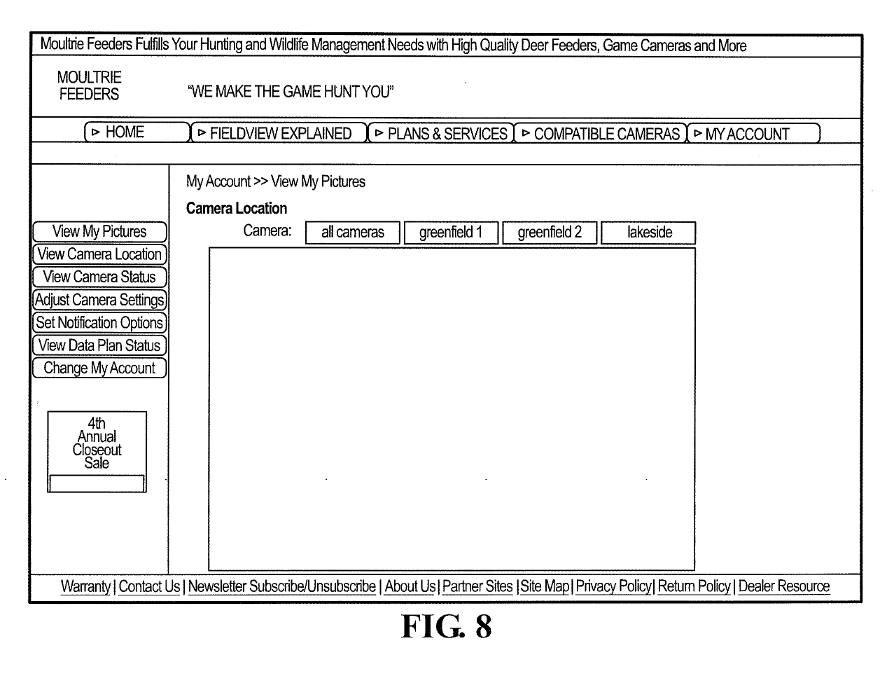

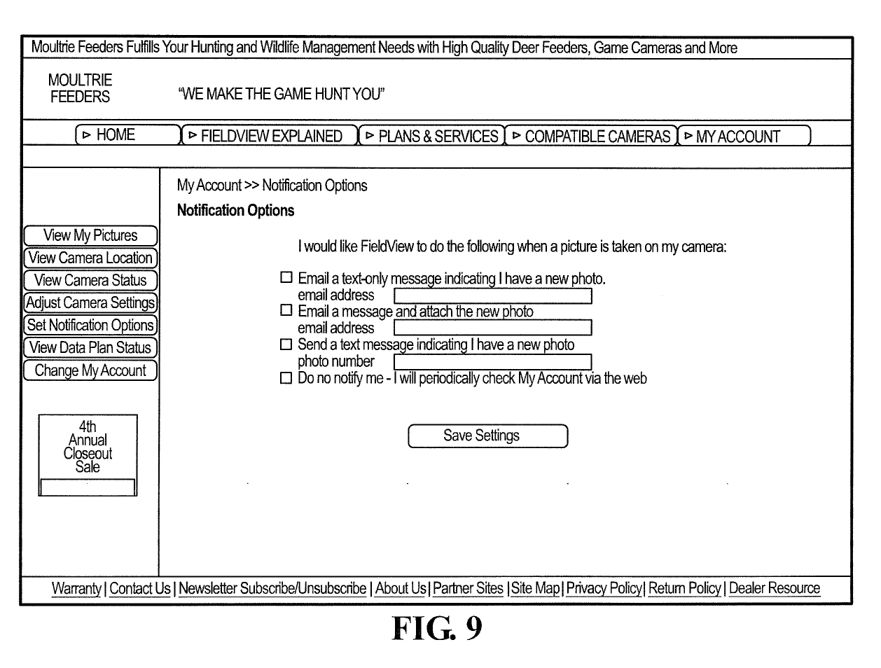

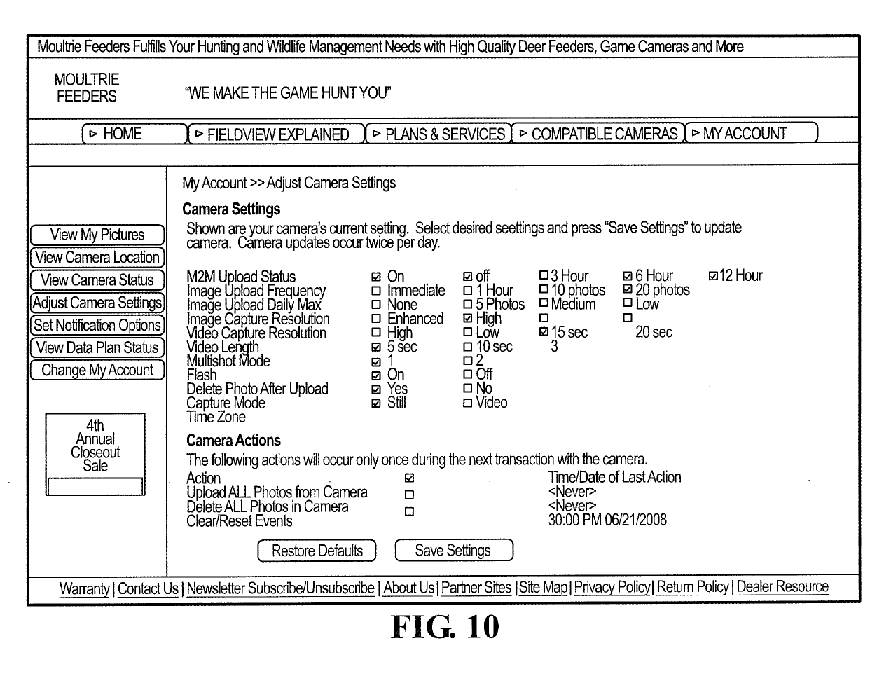

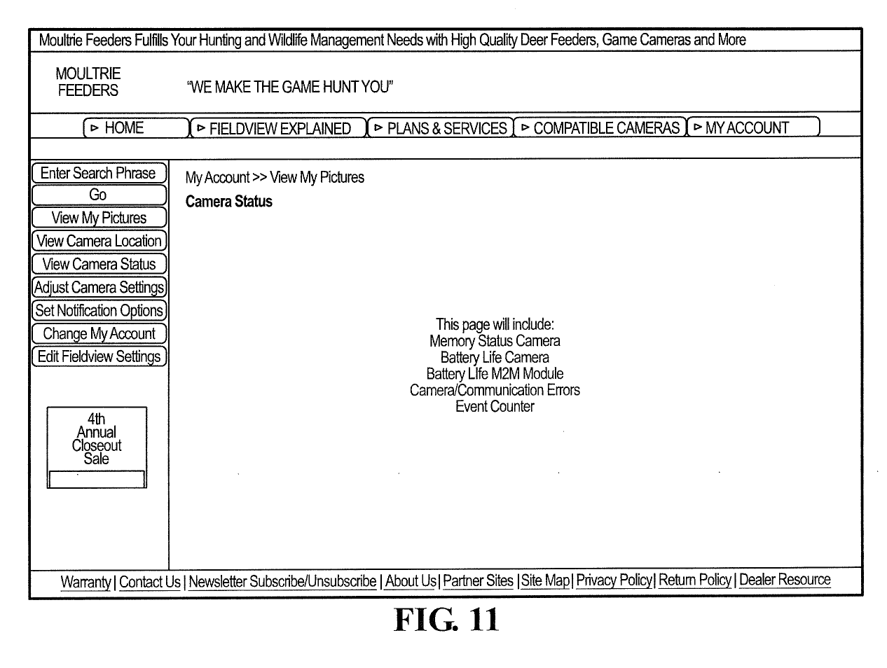

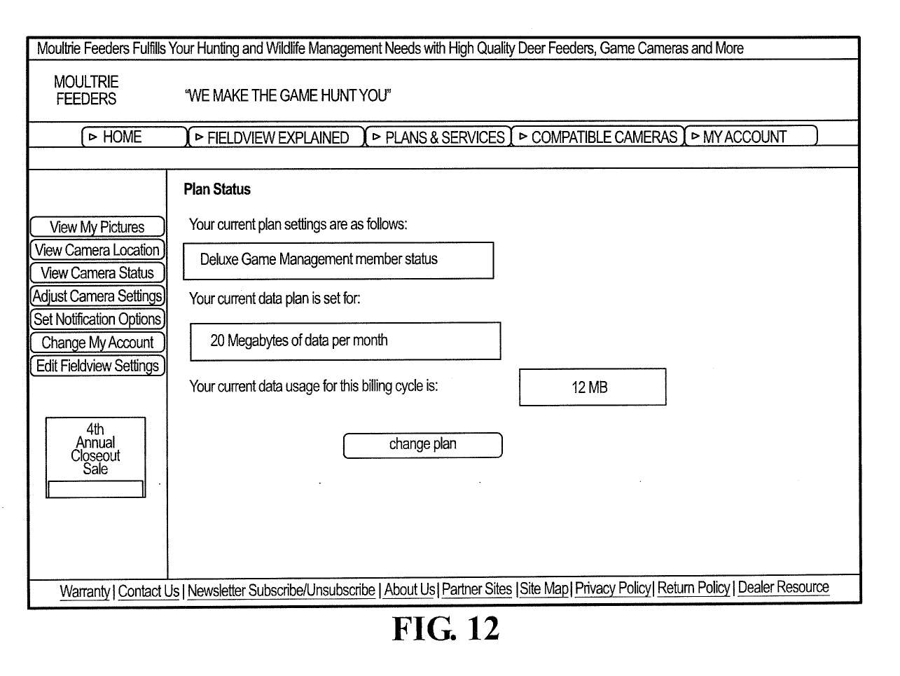

In the embodiment illustrated in FIG. 2, a pair of customer plans (Standard and Deluxe) are available for a user to purchase and access at the customer login. It is to be noted, however, that additional plans with various options may additionally be included. By way of example, with the Standard Plan, the customer is allowed to view pictures and input commands to adjust the field view of the camera 16 (see FIG. 6). All of the settings that can be made on a camera in the field such as delay time between images, picture resolution, can be made from home computer 14 or internet capable smart phone 14 from anywhere in the world, by inputting commands via server 12 and the graphic interface or web page presented by the server at the user location 14. The server 12 may also maintain preferences for the customer, such as notification options (see FIG. 9). With respect to the notification options, the user may determine how to receive a notice that new pictures are available to be viewed, such as receiving an email notice (with or without the associated picture) or a text message to a cellular device. With the Deluxe plan, the customer would have the options already noted and in addition, the customer would have the option of mapping the location of a picture taken by a particular camera 16, and then view the camera location on a map using a variety of software programs known to one having ordinary skill in the art (e.g., Google maps, Yahoo maps, etc.). In addition, the customer could also be able to issue a picture query as noted above, allowing the customer to find all pictures that meet certain requirements or criteria (such as time of day taken, the temperature at the time the picture is taken, etc.).

Referring in more detail to the features offered to customers, the game management website maintained by the server 12 stores image files received from the game camera or cameras 16 located on a particular plot of land in the associated database 13. The images can be enhanced on the customer's work station 14 utilizing any number of image editing software programs well known in the art, such as Photo Shop. The customer may rename the image files and place, or store them into user created folders maintained in the database 13 of the server 12 for later viewing. Furthermore, images can also be e-mailed to another customer of the system 12. The game management website will also plot a GPS location of the camera 16 associated with the particular picture. This can be used by the customer to see where each picture was taken. If the customer is using the apparatus for hunting or wildlife management, then the image will help the user monitor and manage the associated wildlife (e.g., a deer herd) more effectively. In this regard, the database 13 may also provide user definable data fields to be associated with the images maintained in the database 13. For example, experienced hunters can identify the individual animals by their particular markings and/or antlers. The customer also could use these data fields for characterizing the species or sex of the species observed or captured in the image, its activities, such as feeding, mating, or other activities of interest. When combined with the sensor data tagged to the images, either by camera 16 or server 12, the system can provide a robust game management tool such that the user would be able to issue queries as noted above, allowing the user to find all pictures that meet certain requirements or criteria.

While other software-based products only act as a photo storing or sharing website, the method described herein allows the user to obtain pictures with relevant information and search that information to quickly and simply locate relevant pictures. This allows the user to generate reports with corresponding pictures according to the desires of the user (such as to monitor wildlife habits).

It should be understood that the method for monitoring a predetermined photographed area describe above has focused on game management, yet other applications such as is in the security industry will find the invention useful. That is, the game cameras would be positioned in an any area to be monitored, and the pictures taken by the camera would be uploaded, maintained and accessed as described above. Specifically, warehouse complexes, athletic complexes, college and medical campuses, all could be monitored using the present system.

While the invention has been shown and described in preferred forms, it will be apparent to those skilled in the art that many modifications, additions, and deletions can be made therein without departing from the spirit and scope of the invention.

What is claimed is:

1. A system for monitoring a geographic area for activity of interest therein comprising:
One or more motion actuated cameras, capable of capturing images and storing said images as image files, located within the geographic area,
one or more data sensors associated with each of said one or more motion actuated cameras;
each of said one or more motion actuated cameras having associated therewith a wireless communication device operatively connected to said one or more data sensors to transmit electronic information thereto and therefrom;
at least one server on a distributed computer network, operatively connected for wireless communications with said wireless communication device associated with each camera;
at least one electronic database associated with said at least one server and wherein said image files and data files communicated to said at least one server via said wireless communication device are stored and maintained; and
at least one user interface connected to said distributed computer network for use by a user in executing commands and viewing representations of said image files and said data files stored in said at least one electronic database.

2. A system as defined in claim 1, wherein said one or more data sensors include a global positioning system sensor and at least one sensor selected from the group of thermometers, barometers, photocells, humidity sensors, and wind sensors.

3. A system as defined in claim 1, wherein said at least one server is programmed to associate data received from a global positioning sensor associated with any of said one or more motion actuated cameras with all image files received from said associated motion actuated camera.

4. A system as defined in claim 1, further comprising electronic date and time circuitry associated individually with each camera of said one or more motion actuated cameras and operatively connected to create a date and time tag for each of said image files, said date and time tag to be communicated to said at least one server with said image files.

5. A method of monitoring a geographic area comprising the steps of:
a. providing a server connected to a distributed computer system and an electronic database, said electronic database capable of storing various types of data, said server controlling access to said electronic database for storing and retrieving said data therefrom;
b. providing a computer generated interface to users on said distributed computer system to allow users to utilize said server to store and retrieve selected data in said electronic database;
c. receiving, at said server, image files from cameras designated by said users for storage as data in said electronic database;
d. tagging said image files at said server with associated data received from said cameras or sensors associated with said cameras for storage in said electronic database;
e. storing said image files tagged with said associated data in said electronic database; and
f. responding to queries from users through said computer generated interface and displaying image files and said associated data via said computer generated interface.

6. The method as defined in claim 5, wherein said associated data used for tagging said image files includes global positioning data indicating the physical location each of said cameras.

7. The method as defined in claim 6, further comprising providing a mapping tool to plot said physical location of each of said cameras on a display on said interface.

8. The method as defined in claim 5, further comprising sorting said image files and said associated data for display on said interface in accordance with specified aspects of said data.

9. The method as defined in claim 5, further comprising iteratively obtaining additional image and data files not previously sent to said server and tagging and storing any such image files received.

10. The method as defined in claim 9, further comprising providing input capabilities on said user interface to permit users to selectively add data concerning any image file retrieved from storage in said electronic database, said selectively added data being thereafter stored in said electronic database and associated with said image file.

11. The method as defined in claim 1, wherein said at least one user interface is made available to users for a monthly fee.
